(19) United States
(12) Patent Application Publication
(10) Pub. No.: US 2011/0094395 A1
(43) Pub. Date: Apr. 28, 2011

(54) Method and attachment for dewatering logs

(76) Inventor: Dominick O'Reilly, Carton North Tooreen Ballyhaunis (IE)

(21) Appl. No.: 12/589,564

(22) Filed: Oct. 26, 2009

(51) Int. Cl. B30B 9/02; B30B 13/00; B30B 15/30

(52) U.S. Cl. 100/37; 100/110; 100/215

(57) ABSTRACT

A method (200) and press attachment (100) for dewatering logs, are disclosed. The attachment (100) can include: an upper attachment (102) including a press surface (104); a lower attachment (106) having a floor (108) and walls (110) defining a generally U-shaped structure (112) configured to receive a log (114) to be dewatered having predetermined dimensions (130); the upper attachment (102) has an non-actuated mode (116) such that the press surface (104) is spaced a predetermined distance (118) above the lower attachment (106) and an actuated mode (120) such that the press surface (104) is moved vertically downwardly toward the floor (108) and at least partially in the generally U-shaped structure (112). The press surface (104) and the generally U-shaped structure (112) are configured to contact the log (114) at, at least four points or areas (122), (124), (126) and (128). The method (200) and press attachment (100) are adapted for high volume applications. Dewatered logs are easier to shred, provide an improved fuel source and easier to transport.

### FIELD OF THE INVENTION

The present invention relates to an improved method and attachment for dewatering logs.

### BACKGROUND OF THE INVENTION

Throughout the world every year millions of tons of lumber are harvested. Wood has many uses, such as for the construction industry, fuel, shredding for ground cover, etc. In many applications, it is desirable to have dry lumber. In order to achieve low levels of moisture, one needs to have a consistently good drying climate or use vast amounts of energy.

In the wood processing industry, in many important applications, dewatered logs are often preferable over moist wood. For example, for shredding or use as an energy source, dry logs are desirable over moist ones.

A fast, simple in construction and repeatable dewatering process and device would be considered an improvement in the art.

Accordingly, it would be considered an improvement in the art, to be able to remove the moisture from logs and other materials, as quickly, simply, cleanly and economically, as possible.

An improved method and attachment for dewatering logs and solving associated problems, would be considered an improvement in the art.

### BRIEF DESCRIPTION OF THE DRAWINGS

An embodiment of the invention will now be described, by way of example, with reference to the following drawings, in which:

FIG. 1 is a schematic drawing of a lumber dewatering treatment system, in accordance with the instant invention.

FIG. 2 is a cross-sectional view of a sample compression apparatus of FIG. 1.

FIG. 3 is a perspective view of a press attachment and upper attachment, configured to receive logs to be dewatered, in accordance with the instant invention.

FIG. 4 is a simplified side view of the press attachment and upper attachment in FIG. 3, shown with a log to be dewatered, before a press cycle, in accordance with the instant invention.

FIG. 5 is a simplified side view of the press attachment and upper attachment in FIG. 3, shown with a log to be dewatered, with the press cycle begun, in accordance with the instant invention.

FIG. 6 is a simplified side view of the press attachment and upper attachment in FIG. 3, shown with a log to be dewatered, with the press cycle advanced from FIG. 5, in accordance with the instant invention.

FIG. 7 is a simplified partial side view of the press attachment in FIG. 3, shown with a saw tooth inner surface, for transporting water away from a log to be dewatered, in accordance with the instant invention.

FIG. 8 is a simplified side view of the press attachment and upper attachment in FIG. 3, configured with convex and concave surfaces adapted to receive logs to be dewatered, in accordance with the instant invention.

FIG. 9 is a simplified side view of the press attachment and upper attachment in FIG. 3, shown with angled walls for receiving a variety of different sized logs to be dewatered, in accordance with the instant invention.

FIG. 10 is a flow diagram of an embodiment of a method for dewatering logs, in accordance with the invention.

### TECHNICAL DESCRIPTION

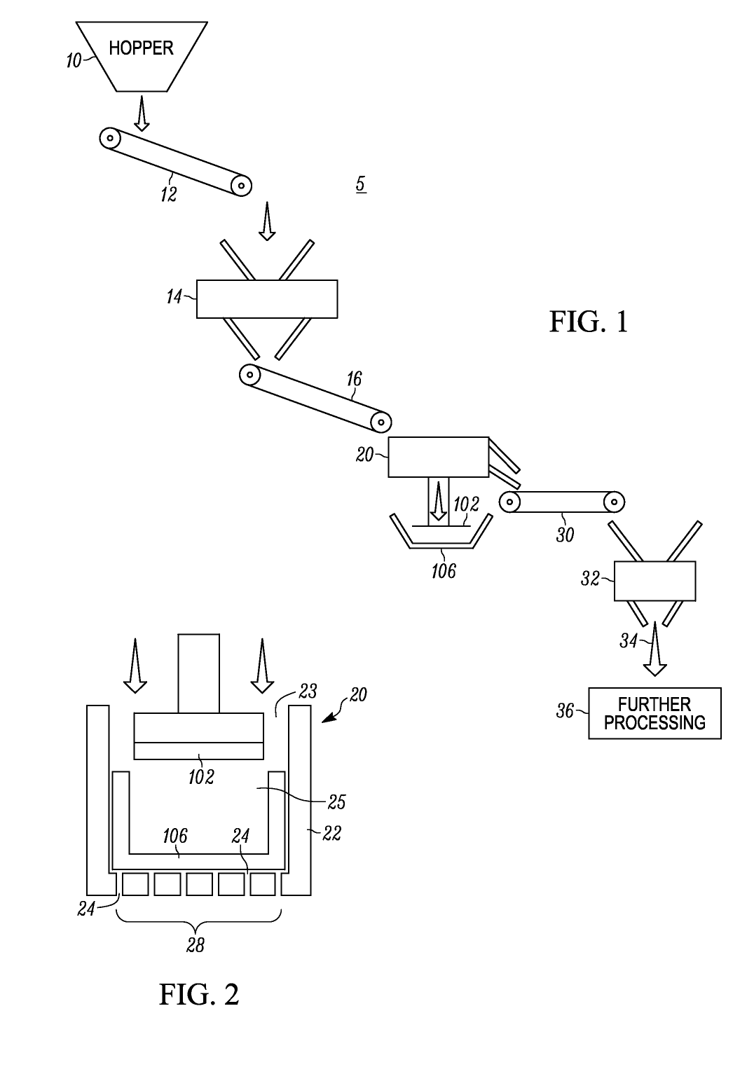

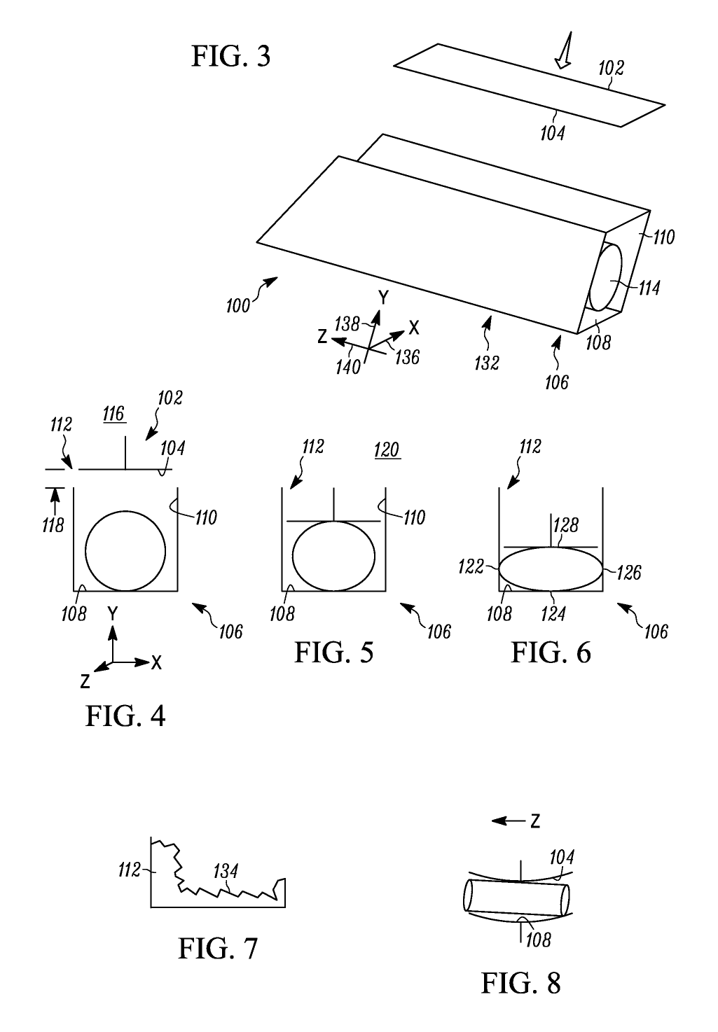

Referring to FIG. 1, a log dewatering system 5 according to one embodiment is shown. As an introduction, logs are collected in a hopper 10. A log is then dispensed from hopper 10 to a conveyor 12 to an alignment apparatus 14. It will be understood by those skilled in the art, that the hopper 10 can be configured to align the logs. Once aligned, a log is conveyed 16, via a piston or conveyor belt, to a press 20, to be dewatered.

The press 20 may be chosen from any one of a belt press, a screw press, a plate press, a batch press, a filter press, a hydraulic press, or any compression device as known in the art. The press 20 is configured to release the moisture in a log during a compression cycle.

For example, the press 20 may comprise a plate press having a conveyor located within the press 20, to firstly convey the log therein, and to secondly, convey or vacate the compressed log out, after compression for further processing. The conveyor can be configured to allow the release of moisture from the log during compression. For example, in the case of a standard belt conveyor, the belt can be perforated to allow the moisture to drain through the conveyor belt. One or more of the plates used in a plate press can also be perforated, to allow the escape of moisture during compression.

As shown in FIG. 2, a simplified cross-section of a sample press 20 is shown. In this case, an enclosed plate press 22 comprising a compression ram 23 and an interior chamber 25, is shown. The press 20 can be provided with a series of apertures 24 to allow the drainage of moisture from the device 20. In FIG. 2, the apertures 24 are provided in the surface of the plate press 22 that the compression ram 23 acts against.

Initially, the ram 23 is maintained in an ‘at rest’ position at that side of the plate press 22 opposite to the apertures 24, for example, the top of the plate press 22.

In operation, the log is supplied to the interior chamber 25 of the plate press 22. During compression, the ram 23 is driven in a downwards direction, towards the apertures 24. As the log is compressed, moisture is forced from the log, in the form of wastewater. The expelled wastewater exits the plate press 20 through the apertures 24, where it is collected in a suitable drain 28.

It will be understood that the above description is a general introduction of the invention. It can be modified and adapted in various ways, to improve the expelling of wastewater during compression. The dewatered log has many beneficial uses, as detailed herein.

The system 5 itself or components thereof may be provided as part of a mobile dewatering unit or system provided as part of a vehicle, for example on the rear of a truck, or on a truck trailer. Once processed, further processing can be taken. For example, a dewatered log can be conveyed, with a conveyer 30, to a storage bin 32, truck container and the like and/or can be conveyed 34 or transported for further processing 36, such as shredding, use as fuel and the like.

Advantageously, a dewatered log has a substantially reduced weight and is thus more easily transportable.

In its simplest form, a press attachment 100 is disclosed. The attachment 100 can include: an upper attachment 102 including a press surface 104; a lower attachment 106 having a floor 108 and walls 110 defining a generally U-shaped structure 112 configured to receive a log 114 to be dewatered having predetermined dimensions 130; the upper attachment 102 has an non-actuated mode 116 such that the press surface 104 is spaced a predetermined distance 118 above the lower attachment 106 and an actuated mode 120 such that the press surface 104 is moved vertically downwardly toward the floor 108 and at least partially in the generally U-shaped structure 112, wherein the press surface 104 and the generally U-shaped structure 112 are configured to contact the log 114 at, at least four points or areas 122, 124, 126 and 128.

This structure provides an improved structure to dewatering logs. The attachment 100, is particularly adapted for being a modular attachment which can be retrofitted in a press, for example. Further, the attachment can be dimensioned to fit the logs to be processed.

In one arrangement, the lower 106 and the upper attachments are generally rectangular 132. This structure is generally at least as long as the log 114 to be dewatered. This structure accommodates various log lengths. Typically, the rectangular shape accommodates the lengths of the logs to be dewatered. Similarly, the U-shaped structure 112 is particularly configured to accommodate the diameter of the log 114.

In one embodiment, a piston or conveyor system is utilized to transport and align the log 114 into the generally U-shaped structure 112. This allows rapid and repeatable loading of logs in proper alignment with the lower attachment 106, as previously detailed.

In one embodiment, an inner portion 134 of the generally U-shaped structure 112 is saw-toothed in shape, as shown in FIG. 7, for improved moisture management and flow of water outwardly away from the log.

In one arrangement, the press surface 104 and a floor 108 of the generally U-shaped structure 112 are complementarily configured such that the press surface 104 is received at least partially in the generally U-shaped structure 112. This structure surrounds the log to be processed, for quick and reliable dewatering.

In one embodiment, in operation, the press surface 104 and the floor 108 provide a gradual application of pressure along a vertical axis, when in the actuated mode 120, to allow water to naturally and freely exit both ends of the log 114 along the natural pathways of the log 114. In more detail, in a preferred embodiment, the gradual application of pressure when in the actuated mode is applied for a predetermined time, sufficient to thoroughly dewater the log. As should be understood, the time can vary widely. For example, the time can be from about 15 to about 60 seconds, for thorough dewatering and providing a commercially viable assembly line like process.

In a preferred arrangement, as shown in FIG. 6, the walls 110 of the generally U-shaped surface 112 provide a gradual application of a horizontal pressure along an horizontal x-axis 136 when in the actuated mode. Advantageously, the horizontal pressure at contact areas 122 and 126 along with the vertical pressure at contact areas 124 and 128, enhances dewatering.

In one arrangement, the press surface 104 and the floor 108 provide a substantial pressure when in the actuated mode, which can vary widely. In one arrangement, it can range from about 500 psi to about 5000 psi.

In another arrangement, as shown in FIG. 8, the press surface 104 and the floor 108 are configured such that a middle portion of the log begins dewatering before outer portions do, for enhanced dewatering since the water in the middle portion has farther to travel to exit than the water nearer the ends. For example, the press surface 104 and the floor 108 can include one being concave and another being convex.

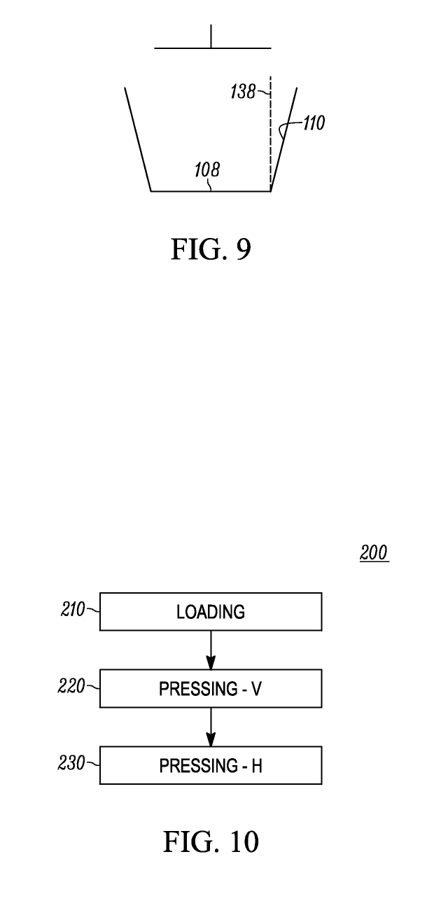

In yet another embodiment, as shown in FIG. 9, the walls 110 are angled with respect to a vertical axis, to accommodate varying diameters of logs. This provides a more universal attachment, for an enhanced flexibly and applicability for various sized logs.

In a preferred embodiment, the press surface 104 is dimensioned and arranged to fit between the walls 110 and in the generally U-shaped structure 112 when actuated, for simplified vertical movement and enhanced decrease of the volume where the log sits, for improved dewatering.

In FIG. 10, a method 200 for dewatering a log is shown. The method 200 can include the steps of: loading 210 a log to be dewatered between a top press attachment including a press surface and a bottom press attachment having a floor and walls defining a generally U-shaped structure configured to receive the log; pressing 220 the log substantially along a vertical axis between the press surface and the floor; and pressing 230 the log substantially along a horizontal axis between the walls. The process is robust and repeatable, for high volume applications. Dewatered logs are easier to shred and provide an improved energy source in most energy applications.

In more detail, and in one embodiment, the method can include: actuating a press causing the press surface to move downwardly along a vertical axis toward the floor and between the walls; decreasing a volume defined by the press surface and the generally U-shaped structure; and expelling water from the log due to the decreased volume. Advantageously, this provides a high volume log dewatering solution for many applications.

The method can include directing the expelled moisture to a catch for simplified drainage.

In one arrangement, before the loading step 210, a transporting step can be utilized to transport a log to a loading location via a piston or a conveyor belt. This can provide a quick and repeatable process.

Likewise, after the pressing steps 220 and 230, an unloading the pressed log and loading a new log is provided. This provides a good assembly line arrangement, for enhanced efficiency.

As should be understood by those skilled in the art, the invention is not limited to the embodiments described herein, and may be modified or varied without departing from the scope of the invention.

I claim:

1. A press attachment including:
an upper attachment including a press surface;
a lower attachment having a floor and walls defining a generally U-shaped structure configured to receive a log to be dewatered having predetermined dimensions;
the upper attachment has an non-actuated mode such that the press surface is spaced a predetermined distance above the lower attachment and an actuated mode such that the press surface is moved vertically downwardly toward the floor and at least partially in the generally U-shaped structure, wherein the press surface and the generally U-shaped structure are configured to contact the log at, at least four points.

2. The press attachment of claim 1, wherein the lower and the upper attachments are generally rectangular.

3. The press attachment of claim 1, further comprising a piston or conveyor system being utilized to transport the log into the generally U-shaped structure.

4. The press attachment of claim 1, wherein an inner portion of the generally U-shaped structure is saw-toothed in shape, to allow water to flow outwardly away from the log.

5. The press attachment of claim 1, wherein the press surface and a floor of the generally U-shaped structure are complementarily configured such that the press surface is received at least partially in the generally U-shaped structure.

6. The press attachment of claim 1, wherein the press surface and a floor of the generally U-shaped surface provide a gradual application of pressure along a vertical axis, when in the actuated mode to allow water to naturally exit both ends of the log along the natural pathway of the log.

7. The press attachment of claim 1, wherein the press surface and a floor of the generally U-shaped surface provide a gradual application of pressure when in the actuated mode for a predetermined time sufficient to dewater the log.

8. The press attachment of claim 1, wherein the press surface and a floor of the generally U-shaped surface provide a gradual application of pressure when in the actuated mode for from about 15 to about 60 seconds. TA

9. The press attachment of claim 1, wherein the walls of the generally U-shaped surface provide a gradual application of pressure along a horizontal axis when in the actuated mode.

10. The press attachment of claim 1, wherein the press surface and the floor of the generally U-shaped surface provide a pressure when in the actuated mode ranging from about 500 psi to about 5000 psi.

11. The press attachment of claim 1, wherein the press surface and the floor are configured such that a middle portion of the log begins dewatering before outer portions do.

12. The press attachment of claim 1, wherein the press surface and the floor include one being concave and an other being convex.

13. The press attachment of claim 1, wherein the walls are angled with respect to a vertical axis.

14. The press attachment of claim 1, wherein the press surface is dimensioned to fit between the walls of the generally U-shaped surface when actuated.

15. The press attachment of claim 1, wherein the generally U-shaped structure extends about one meter long.

16. A method for dewatering a log, comprising:
loading a log to be dewatered between a top press attachment including a press surface and a bottom press attachment having a floor and walls defining a generally U-shaped structure configured to receive the log; and pressing the log substantially along a vertical axis between the press surface and the floor and pressing the log substantially along a horizontal axis between the walls.

17. The system of claim 16, further comprising actuating a press causing the press surface to move downwardly along a vertical axis toward the floor and between the walls; decreasing a volume defined by the press surface and the generally U-shaped structure; and expelling water from the log due to the decreased volume.

18. The system of claim 16, further comprising directing the expelled moisture to a catch for draining.

19. The system of claim 16, further comprising before the loading step, transporting a log to a loading location via a piston or a conveyor belt.

20. The system of claim 16, further comprising after the pressing step, unloading the pressed log and loading a new log.
